(19) United States
(12) Patent Application Publication
(10) Pub. No.: US 2006/0037833 A1
(43) Pub. Date: Feb. 23, 2006

(54) Conveyor flow track systems, methods, and apparatus

(76) Inventors: Robert Joseph Lawless, Acworth, GA (US); Rumen V. Stoyanov, Acworth, GA (US)

Correspondence Address: JOHN S. PRATT, ESQ;KILPATRICK STOCKTON, LLP, 1100 PEACHTREE STREET, ATLANTA, GA, 30309, US

(21) Appl. No.: 11/208,083

(22) Filed: Aug. 19, 2005

Related U.S. Application Data
(60) Provisional application No. 60/603,102, filed on Aug. 19, 2004.

(51) Int. Cl. B65G 13/00

(52) U.S. Cl. 193/35 R

(57) ABSTRACT

The present invention comprises an adaptable transfer conveyor for the storage and movement of goods. In one embodiment of the invention, a transfer structure for conveying a load from a first location to a second location is provided. The transfer structure can include at least one profile capable of supporting a wheel assembly, and a plurality of wheel assemblies capable of conveying a load. Each wheel assembly can include an axle with at least one end capable of mounting to the at least one profile. Each wheel assembly can also include at least one wheel rotatably mounted to the axle, the at least one wheel capable of contacting a portion of the load. Furthermore, each wheel assembly can also include a spring capable of maintaining the position of the respective wheel assembly with the at least one profile, and further capable of permitting the manual removal of the respective wheel assembly from the at least one profile when the spring is compressed against either the at least one wheel or the at least one profile.

### RELATED APPLICATION

This application claims priority to U.S. Provisional Application Ser. No. 60/603,102, entitled “Conveyor Flow Track Systems, Methods, and Apparatus,” filed on August 19, 2004, the contents of which are hereby incorporated by reference.

### FIELD OF THE INVENTION

This invention relates to conveyor systems, and in particular, to improved transfer conveyor systems, methods, and apparatus for the storage and movement of goods.

### BACKGROUND OF THE INVENTION

A steel wheel track system, or skate wheel track system, is one conventional type of flow track system used in the material handling industry. The steel wheel track system can comprise a track assembly including one or more parallel track frames. Each track frame can include a pair of parallel steel frame members, also known as “profiles,” and multiple wheel assemblies mounted between the profiles. Each wheel assembly can include a steel wheel rotatably mounted on an axle that extends between the profiles transverse to the track flow direction. Ball bearings can be used in the wheels to increase the load capacity of the wheels and to enable the wheels to roll.

Another conventional type of flow track system utilizes relatively wide rollers instead of wheels. This type of “wide-roller” track system can comprise a track assembly including one or more parallel track frames. Each track frame can include a pair of parallel steel frame members, also known as “profiles,” and multiple roller assemblies mounted between the profiles. Each roller assembly can include a steel roller rotatably mounted on an axle that extends between the profiles transverse to the track flow direction.

The terms “transfer conveyor,” “transfer structure,” and “flow track system” are used interchangeably in this document, and are intended to generally describe conveyor systems for storing and transporting goods.

Drawbacks can exist with the types of systems described above. In some instances, the types of systems described above can be used to transport various shapes and sizes of cartons or boxes. However, space utilization can be a consideration for users especially when loads such as cartons and boxes are not uniform in shape or size. For example, wide-roller type systems may not be able to achieve relatively high space utilization if a particular carton width is greater than or less than the width of the underlying roller.

Furthermore, maintenance of these types of systems can be another consideration for users of these types of systems. When wheels and rollers are subjected to relatively high impact forces, these parts and associated components such as axles and supports may need to be replaced on a regular basis.

As a result, it is desirable to provide improved transfer conveyor systems, methods, and apparatus for the storage and movement of goods.

### SUMMARY OF THE INVENTION

The present invention relates to transfer structures enabling goods such as cartons to be transferred, for instance, from one portion of a transfer conveyor to another portion of the transfer conveyor by providing structures that permit various sizes and shapes of cartons to move between the portions of the transfer conveyor. The improved transfer structures can provide roller contact between at least a portion of the underside of the cartons some or all of time. Further, the present invention relates to a wheel apparatus for a transfer conveyor that can be interchanged relatively quickly without special tools. The present invention also relates to securing the position of a wheel apparatus for a transfer conveyor. Furthermore, the present invention relates to a structural support apparatus that can be adapted to improve the load capacity of a transfer conveyor. Moreover, the present invention relates to a flow control apparatus to control the movement of a load on a transfer conveyor. Methods of using the above systems and apparatus are also described.

In one embodiment of the invention, a transfer structure for conveying a load from a first location to a second location is provided. The transfer structure can include at least one profile capable of supporting a wheel assembly, and a plurality of wheel assemblies capable of conveying a load. Each wheel assembly can include an axle with at least one end capable of mounting to the at least one profile. Each wheel assembly can also include at least one wheel rotatably mounted to the axle, the at least one wheel capable of contacting a portion of the load. Furthermore, each wheel assembly can also include a spring capable of maintaining the position of the respective wheel assembly with the at least one profile, and further capable of permitting the manual removal of the respective wheel assembly from the at least one profile when the spring is compressed against either the at least one wheel or the at least one profile.

Objects, features, and advantages of various embodiments of the invention include:

(1) Improved transfer structures and means for storing and transferring goods;

(2) Methods and apparatus for interchanging a wheel assembly for transfer conveyor systems;

(3) Methods and apparatus for securing the position of a wheel assembly for transfer conveyor systems;

(4) Methods and apparatus for improving structural support of transfer conveyor systems; and

(5) Methods and apparatus for controlling movement of a load on transfer conveyor systems.

Other objects, features and advantages of various embodiments according to the invention are apparent from the other parts of this document.

### BRIEF DESCRIPTION OF THE DRAWINGS

FIGS. 1-2 illustrate a transfer structure for a freewheel flow system in accordance with an embodiment of the invention.

FIGS. 3-4 illustrate another embodiment of a transfer structure for a freewheel flow system in accordance with an embodiment of the invention.

FIGS. 5-7 illustrate components for a freewheel flow system in accordance with an embodiment of the invention.

FIGS. 8A-8B illustrate a wheel assembly for a freewheel flow system in accordance with an embodiment of the invention.

FIGS. 9-15 illustrate examples of wheel assemblies for a freewheel flow system in accordance with an embodiment of the invention.

FIGS. 16-24 illustrate components for a freewheel flow system in accordance with an embodiment of the invention.

FIGS. 25A-25C and 26-29 illustrate examples of a flow control apparatus for a freewheel flow system in accordance with an embodiment of the invention.

### DETAILED DESCRIPTION OF EMBODIMENTS OF THE INVENTION

The present invention relates to transfer structures enabling goods such as cartons to be transferred, for instance, from one portion of a transfer conveyor to another portion of the transfer conveyor by providing structures that permit various sizes and shapes of cartons to move between the portions of the transfer conveyor. The improved transfer structures can provide roller contact between at least a portion of the underside of the cartons some or all of time. Further, the present invention relates to a wheel apparatus for a transfer conveyor that can be interchanged relatively quickly without special tools. The present invention also relates to securing the position of a wheel apparatus for a transfer conveyor. Furthermore, the present invention relates to a structural support apparatus that can be adapted to improve the load capacity of a transfer conveyor. Moreover, the present invention relates to a flow control apparatus to control the movement of a load on a transfer conveyor. Methods of using the above systems and apparatus are also described.

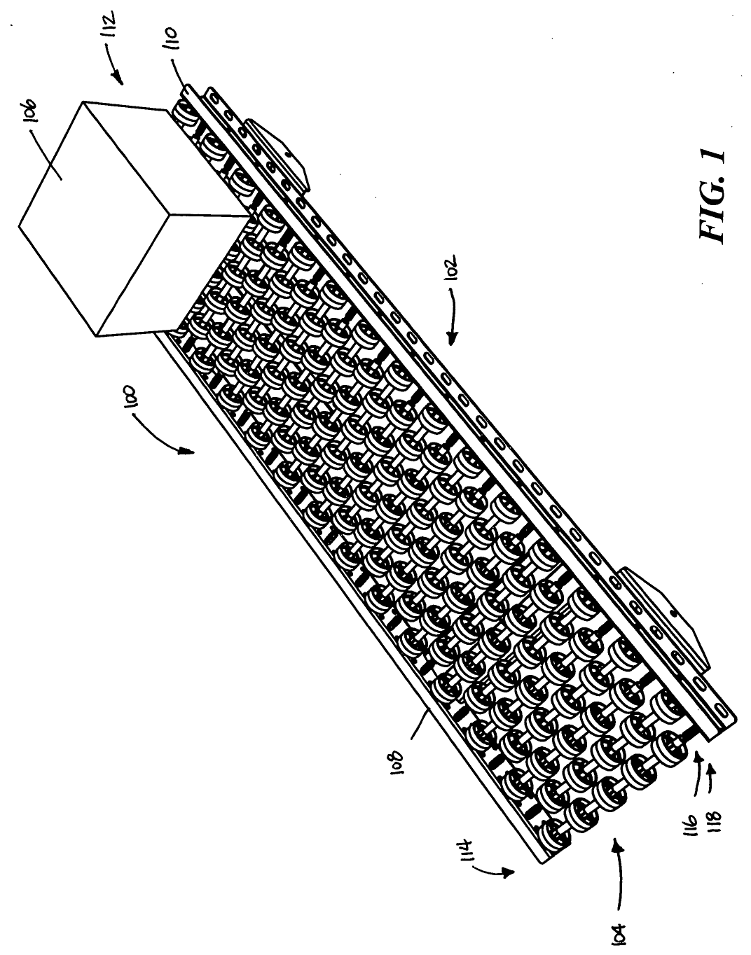

FIG. 1 illustrates a perspective view of an embodiment of a transfer structure 100 for a freewheel flow system. In this example, the transfer structure 100 comprises a track assembly 102 and a series of wheel assemblies 104. The transfer structure 100 shown can be mounted in an end-to-end, side-by-side, or otherwise adjacent orientation with at least one other transfer structure 100. Implementations of this particular embodiment are manufactured and distributed by Creative Storage Systems, Inc. of Kennesaw, Ga.

In use, a transfer conveyor 100 can support a load such as a carton 106. The carton can comprise a box that is representative of cartons commonly used in picking applications or warehouse and/or distribution environments. A bottom panel (not shown) of the carton can contact an upper portion of some of the wheel assemblies 104. When the carton 106 is placed on an upper portion of the wheel assemblies 104, the carton 106 can be transported over the wheel assemblies 104 and along the length of the track assembly 102. Various sizes and shapes of loads can be handled in this manner by the transfer structure 100.

The track assembly 102 shown comprises a pair of longitudinally extending track frames or side channels 108, 110 extending from an entrance end 112 to an exit end 114, and wheel assemblies 104 mounted to each track frame or side channels 108, 110 for maintaining rolling engagement with a load such as a carton 106 on an upper surface of a portion of the wheel assemblies 104. The wheel assemblies 104 can be arranged in a row or series extending from the entrance end 112 to the exit end 114. Each of the wheel assemblies 104 includes an associated spring 116 enabling each wheel assembly 104 to be manually removed from the track frames or side channels 108, 110 if repair or replacement is needed. An associated positioning clip 118 or device can also be used with each wheel assembly 104 to secure the position of the wheel assembly 104 with respect to the track frames or side channels 108, 110. Loads such as cartons 106 can be supported by the track assembly 102 and associated wheel assemblies 104, and can be further transported in a track flow direction extending from the entrance end 112 to the exit end 114.

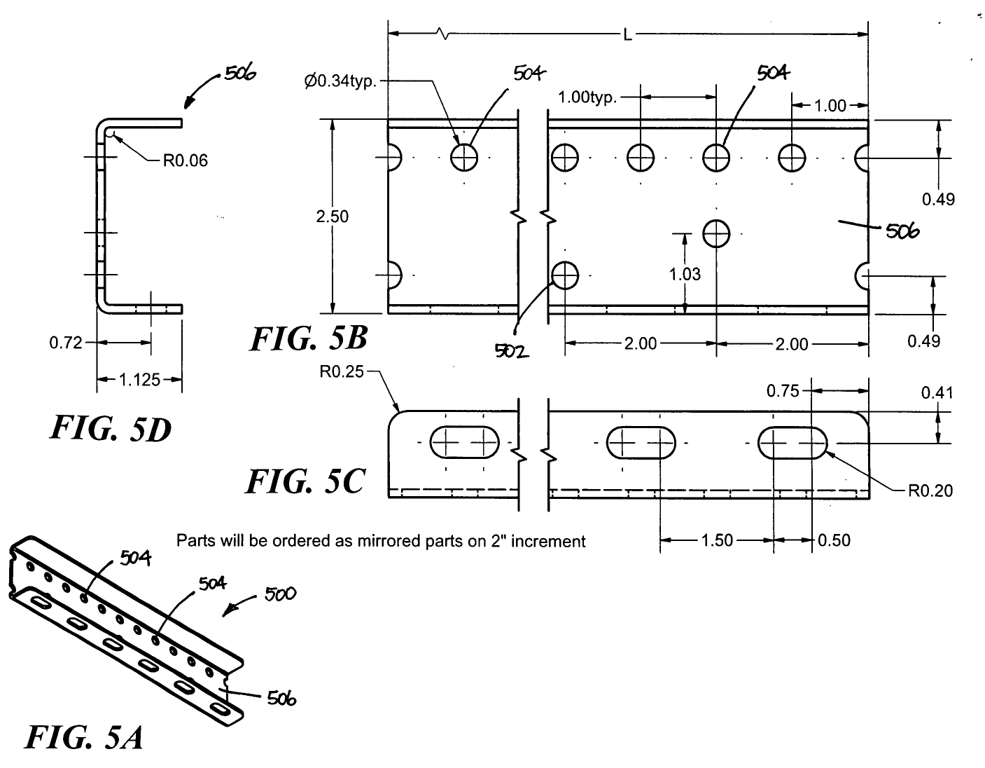

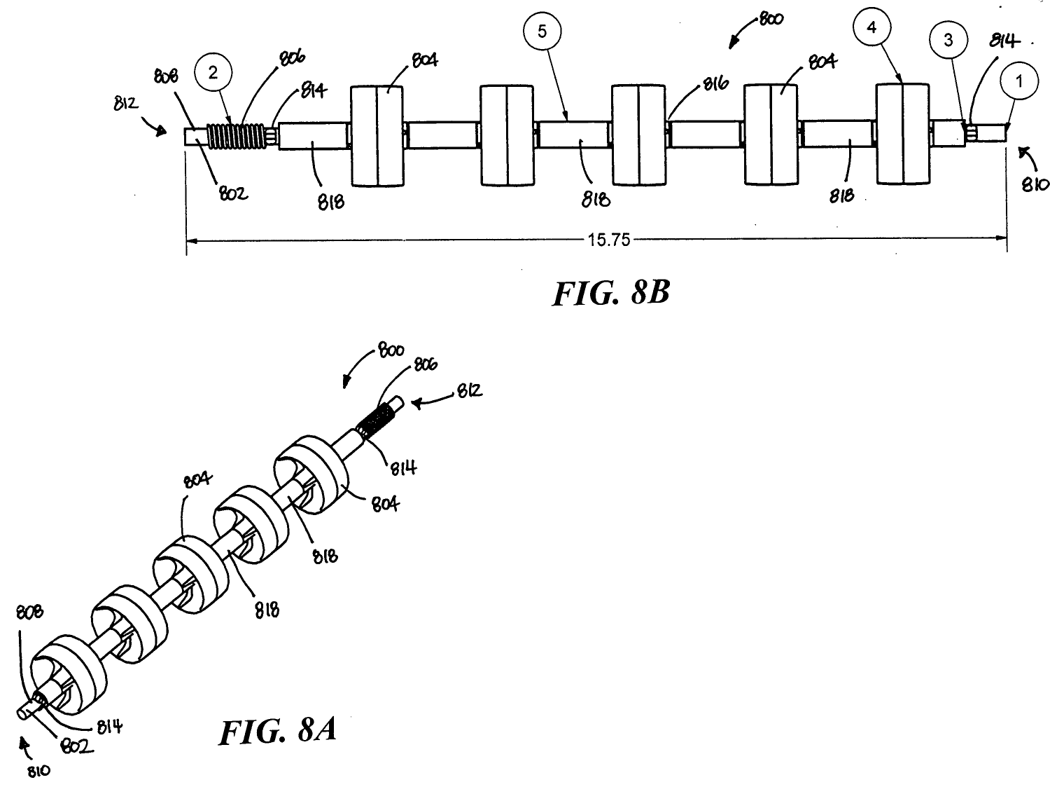

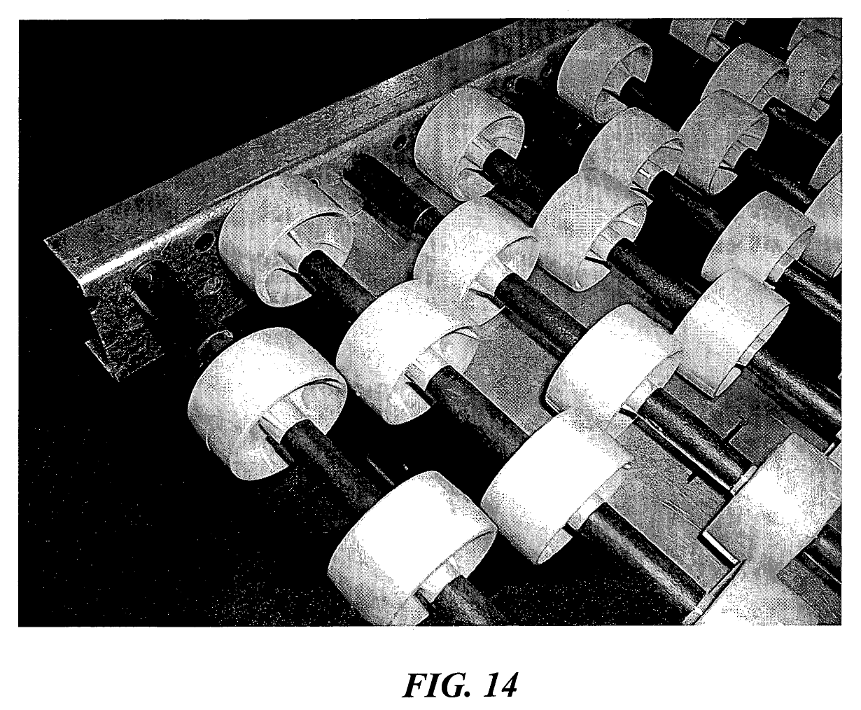

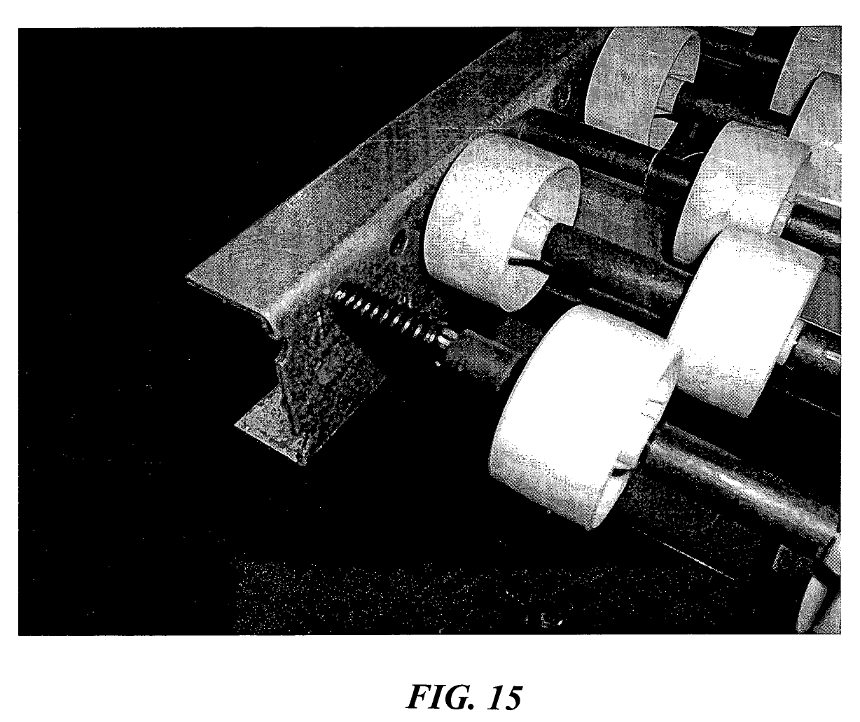

Examples of components for a track assembly are shown and described in FIGS. 5A-7A below. Examples of components for wheel assemblies 104 are shown and described in greater detail in FIGS. 8A, 8B, and 12-15 below.

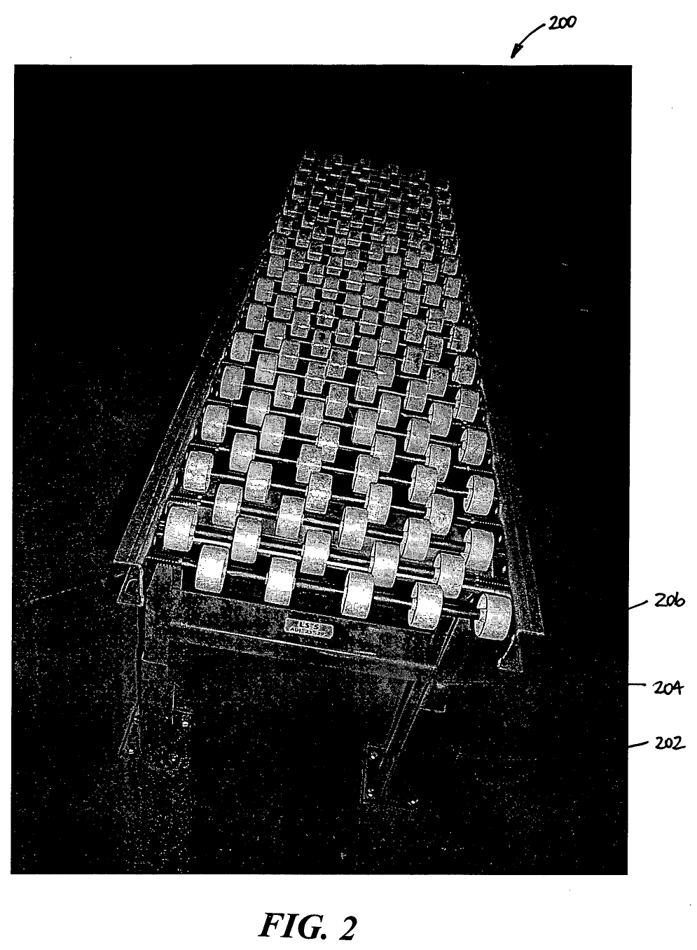

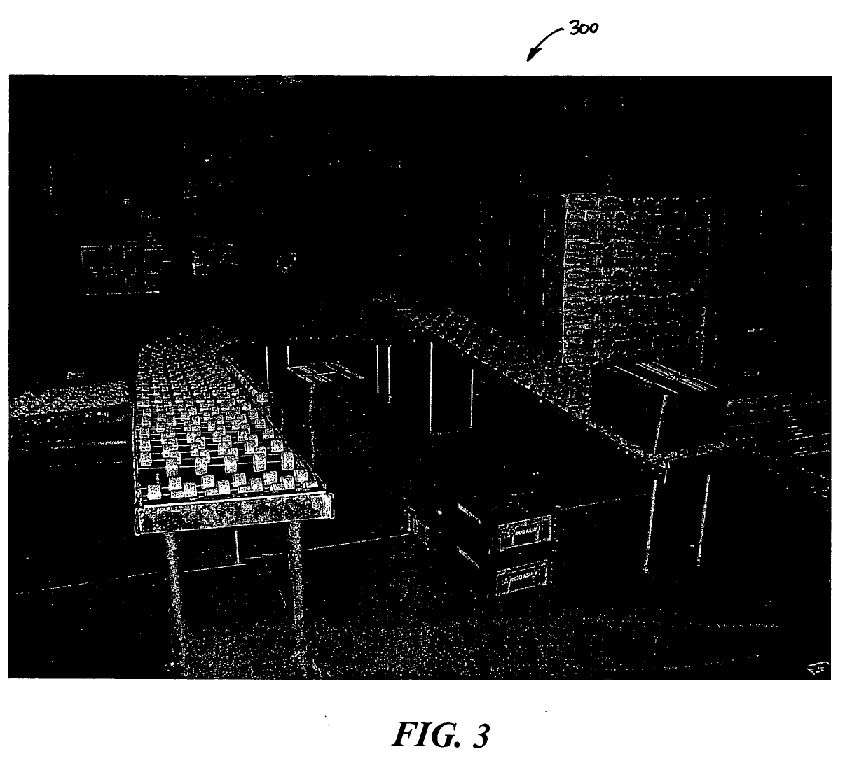

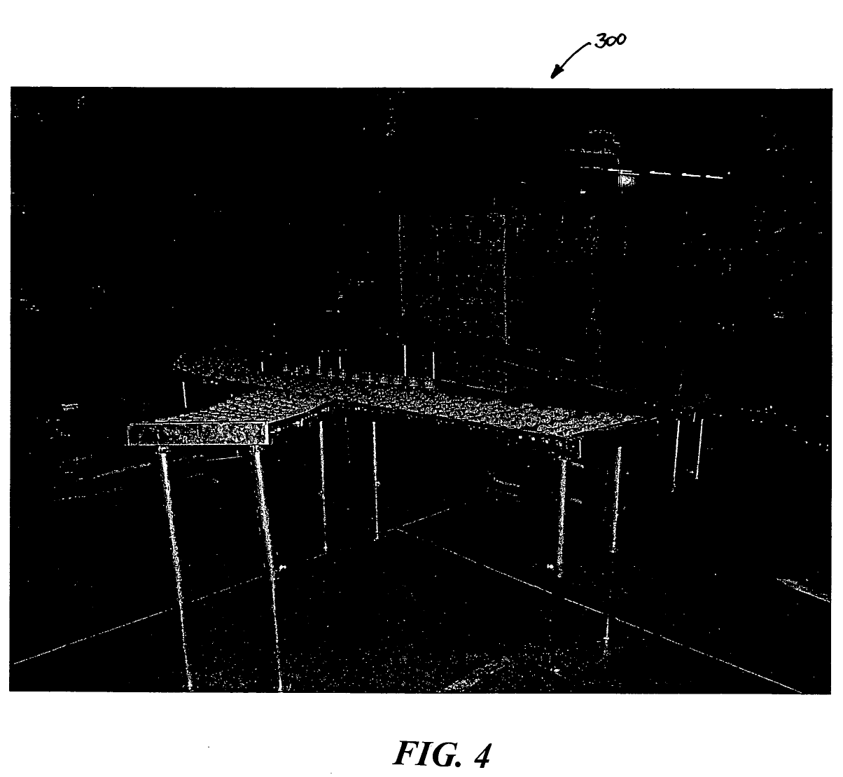

FIG. 2 illustrates a front view of another embodiment of a transfer structure in accordance with the invention. As shown in FIG. 2, a transfer structure 200 can include a support structure 202, typically (though not necessarily) in an inclined orientation, with one or more supports 204. A track assembly 206 can be elevated above the ground by the support structure 202 and associated supports 204. An example of another embodiment of a transfer structure supported by a different type of support structure is shown in FIGS. 3 and 4. For example, the embodiment in FIG. 2 includes channel-shaped components for the support structure, whereas the embodiment in FIGS. 3 and 4 includes tubular-shaped components for the support structure.

FIGS. 5A-5D, 6, and 7A-7E illustrate components for a track assembly, and FIGS. 8A, 8B, and 12-15 illustrate components for wheel assemblies, in accordance with an embodiment of the invention. As disclosed above in FIG. 1, a wheel assembly 104 can be manually removed from a track frame or side channels 108, 110 if repair or replacement is needed. In the examples provided, the design of the track assembly 102 and wheel assemblies 104 permits a user to manually replace a wheel assembly 104 without special tools or equipment, or without extensive disassembly of the transfer structure 100.

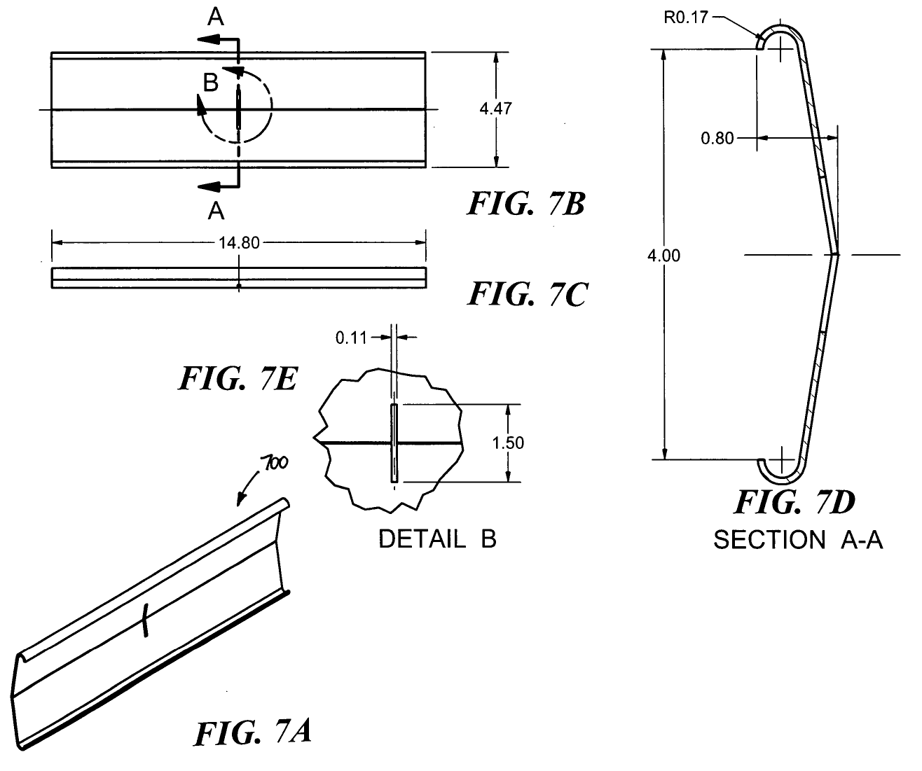

Referring back to FIG. 1, the track assembly 102 shown can include a first, or left side channel 108 and a second, or right side channel 110. In some embodiments, side channels are also known as “profiles.” Each of the side channels 108, 110 can be supported by a support structure, such as 202 in FIG. 2. One or more relatively long spacers, shown as 700 in FIG. 7, or threaded fastening rods can fasten the side channels 108, 110 together in a spaced apart relationship, forming a relatively wide channel between the side channels 108, 110. That is, the width of the channel can be relatively greater than the width of an associated load such as a carton. In other embodiments, the width of the channel can be relatively smaller than the width of a carton or other load.

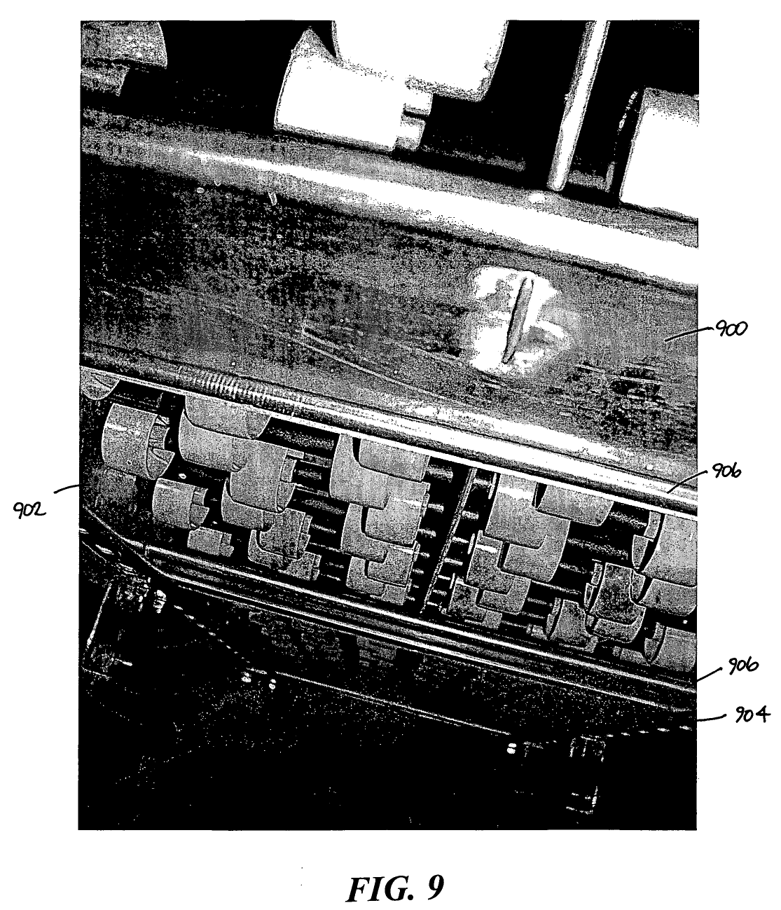

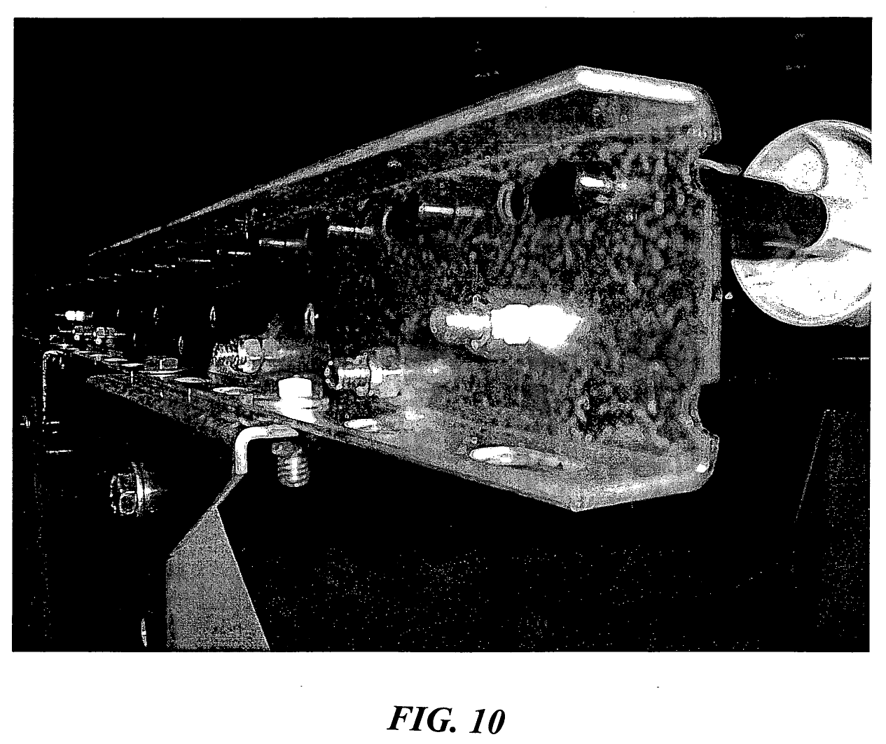

FIGS. 5A-5D illustrate perspective, side, lower, and end views, respectively, of an example of a side channel 500, similar to that shown as 108, 110 in FIG. 1. The side channel 500 shown can include a series of channel mounting holes 502, axle mounting holes 504, and a C-shaped body 506. The channel mounting holes 502 can be aligned with corresponding channel mounting holes of another channel. As shown in FIG. 9, spacers 900 can be fastened between selected corresponding pairs of channels 902, 904. Other examples of spacers are illustrated in FIG. 9, such as threaded fastening rods 906. Threaded rods can be fastened between selected pairs of channel mounting holes, such as 502 shown in FIG. 5, as necessary to secure or otherwise position the channels 902, 904 relative to each other. Furthermore, axle mounting holes 504 of a side channel 500 can be aligned with corresponding axle mounting holes of another side channel for receiving axles of wheel assemblies 104. The C-shaped body 506 can receive various connecting devices adjacent to the ends of the side channel 500 to connect the side channel to other components of a transfer structure 100, such as another side channel for another track assembly. Connecting devices can include splice bars, angle splice bars, extension hooks, connecting bars, mounting bars, stops, impact trays, and other suitable devices in accordance with embodiments of the invention. For example, multiple track assemblies can be connected together to form the transfer conveyor structure 300 shown in FIGS. 3 and 4.

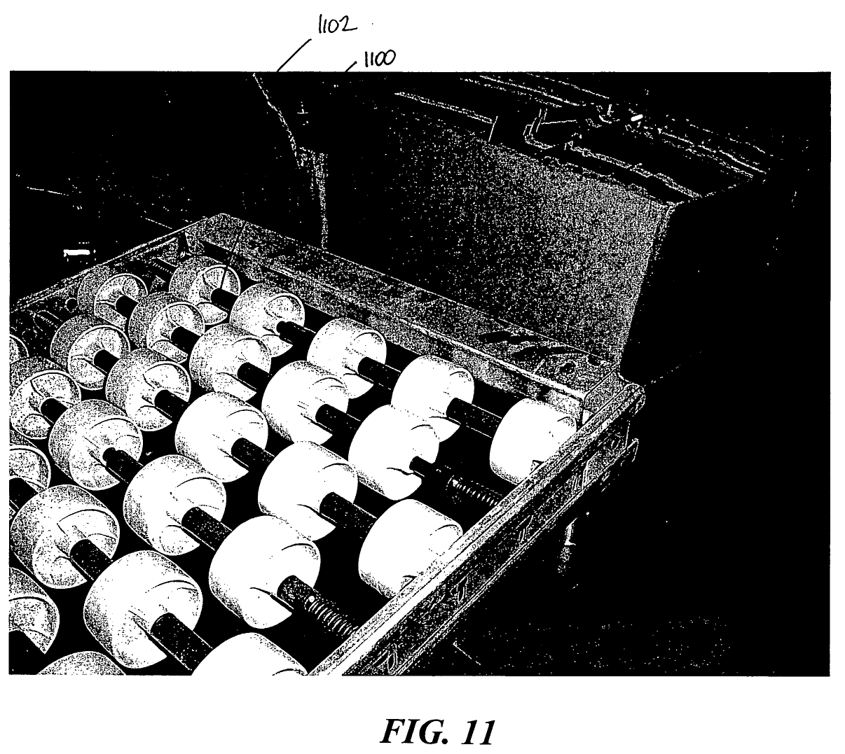

Embodiments of a wheel assembly are shown in detail in FIGS. 8A, 8B, and 11. The wheel assemblies shown can be installed with respect to a transfer structure, relatively quickly as needed, and without special tools or equipment, or without extensive disassembly of the transfer structure. As shown in FIGS. 8A and 8B, each wheel assembly 800 can include a multi-wheel axle 802, multiple polycarbonate resin wheels 804 rotatably mounted on the axle 802, and a spring 806 rotatably mounted adjacent to one end of the axle 802. The wheels 804 of a given wheel assembly can be mounted along the axle 802 in a row extending transverse to the track flow direction. An example of a wheel is shown and described in U.S. application Ser. No. 09/956,253, entitled “Freewheel Flow Track Systems,” filed on Sep. 20, 2001. Springs 806 can be constructed from steel, but may be constructed from any other suitable metal or material, or combination thereof.

As shown in FIGS. 8A and 8B, an axle 802 can include a shaft portion 808, one head portion 810 adjacent one end of the shaft portion 808, a second head portion 812 adjacent an opposing end of the shaft portion 808, and a wheel securing means 814. An axle 1100 for a wheel assembly 1102 in FIG. 11 can have similar features. The wheel securing means 814 shown can include, but is not limited to, a mechanical dimple in the axle, a locking device, a nut, a bead, or any other suitable device that can secure the position of a wheel 804 relative to the axle 802. Axles 802 can be constructed from steel, but may be constructed from any other suitable metal or material, or combination thereof. The shaft portions 808 can be coated with a lubricant coating 816 that is applied to and bonded with the shaft portion 808. For example, a suitable lubricant coating can be fluorocarbon-based or Teflon-based, and can be heated to a relatively high temperature to fix to and bond with the shaft portion.

The wheel assembly 800 of FIGS. 8A and 8B can also include one or more axle spacers 818. The wheel assembly 1102 in FIG. 11 can have similar features and components of the wheel assembly in FIGS. 8A and 8B. Axle spacers 818 can be mounted on the axle 802 between consecutive or otherwise adjacent wheels 804 of the assembly 800. The axle spacers 818 can secure each of the wheels 804 in a desired position along the axle 802. Various numbers and/or sizes of spacers 818 can be used in each wheel assembly 800, and the arrangement of the spacers 818 and wheels 804 in a wheel assembly 800 can be varied to change the position of the wheels 804 along the axle 802 as desired. The spacers 818 can include spacer slits to allow the spacers to be mounted to, such as snapped onto and off of, the axle 802, thus facilitating the task of changing the positions of the wheels 804 along the axle 802.

The wheel assemblies 800, 1102 shown can be installed in a similar manner with respect to a track assembly, shown as 102 in FIG. 1, wherein the axle 802, 1100 extends between side channels, such as 108, 110 in FIG. 1 or 500 in FIG. 5, transverse to the track flow direction. With respect to FIGS. 8A and 8B, the head portions 810, 812 of the axle 802 can be mounted within axle mounting holes such as 804 in FIG. 8. To mount the head portions of an axle 802 in axle mounting holes, the head portion of the axle adjacent to the spring 806, in this example head portion 810, is first inserted into an axle mounting hole of a first side channel, such as 108. The spring 806 is compressed between a surface of the side channel 108 and the wheel securing means 814 or wheel 804, until the opposing or second head portion of the axle, in this example head portion 812, can be inserted into an axle mounting hole of a second, or opposing side channel, such as 110. When the compression force on the spring 806 is released, a return force generated by the spring 806 causes the spring 806 to remain in contact with the first side channel 108 and in a position between the surface of the first side channel 108 and the wheel securing means 814 or wheel 804. In this manner, the wheel assembly 800 of FIGS. 8A and 8B can be manually installed relatively quickly and without special tools or equipment. The wheel assembly 1100 of FIG. 11 can be installed in a similar manner.

In some instances, the head portion 810 and second head portion 812 of an axle 802 can extend through more than one axle mounting holes at a time, such as through the axle mounting hole in side channel 500 and a concentrically aligned axle mounting hole in an adjacent side channel. In this manner, the axle 802 can connect components of a transfer structure 100 together, such as a side channel 500 and an adjacent side channel.

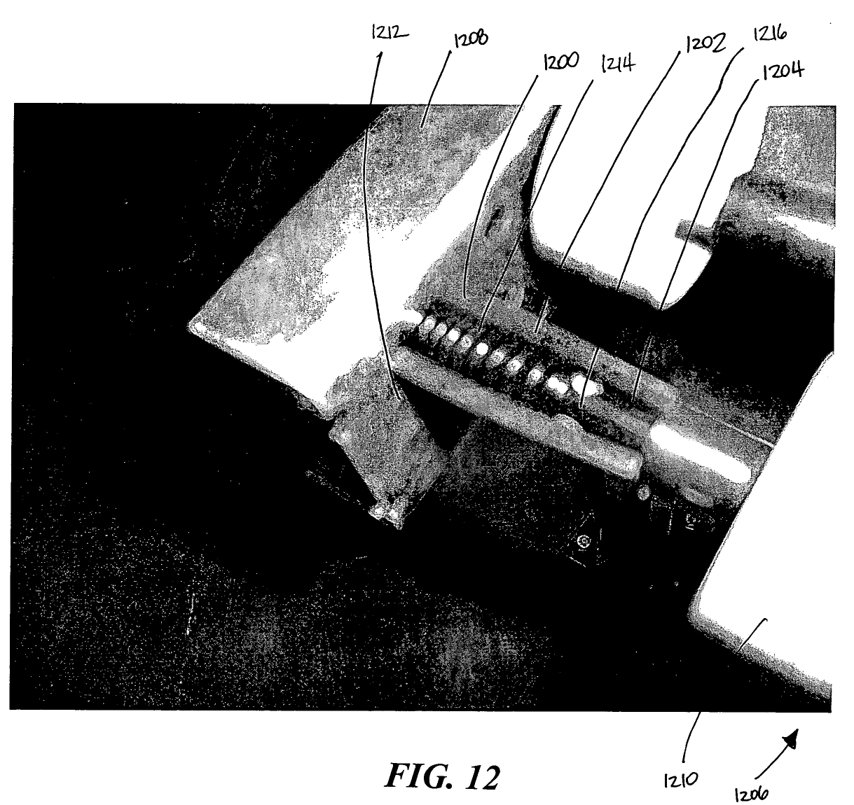

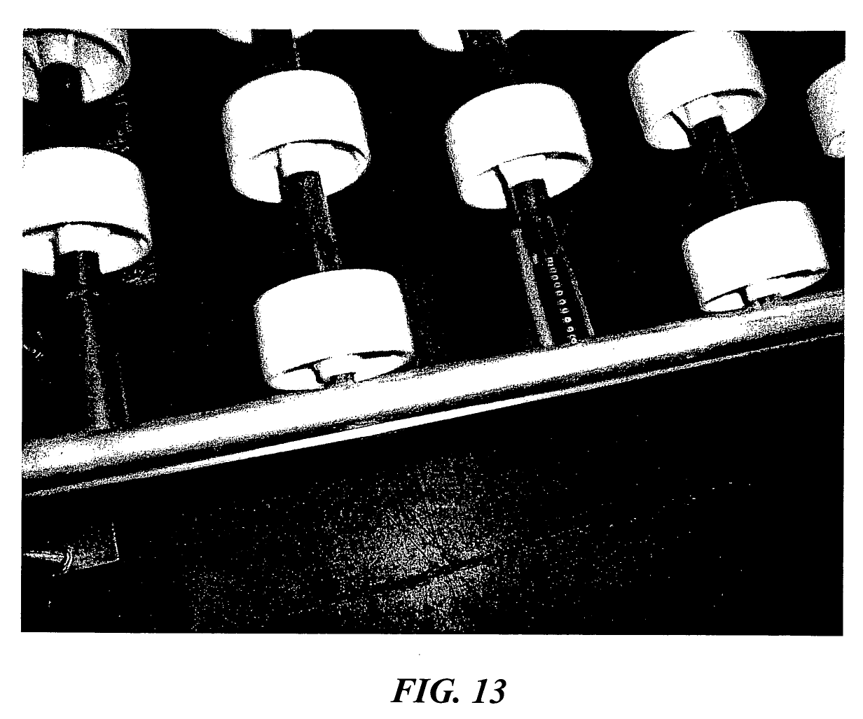

The wheel assemblies 800, 1102 can also include a positioning clip, as shown in FIGS. 12-15. The positioning clip shown in these figures provides an apparatus for securing the position of a wheel assembly with respect to at least one side channel of a transfer structure. Referring to FIG. 12, a positioning clip 1200 can include a body 1202, and a slit 1204. In the example shown, the positioning clip 1200 can be adapted to secure the position of a wheel assembly 1206 with respect to at least one side channel 1208. The positioning clip 1200 can be sized to fit between a spacer 1206 adjacent to a wheel 1210 and an interior surface 1212 of the side channel 1208, and further sized to fit around a portion of a spring 1214 associated with an axle 1216 for the wheel assembly 1206. Positioning clips 1200 can be mounted to, such as snapped onto, the spring 1214. When the positioning clip 1200 is secured to the spring 1214, the axle 1216 cannot be removed from an axle mounting hole in the side channel 1208 since the spring 1214 cannot be compressed against the side channel 1208, thus the position of the wheel assembly 1206 can be secured with respect to at least the side channel 1208. Other views of a positioning clip similar to 1200 in FIG. 12 are shown in FIGS. 13-15.

To remove a wheel assembly, such as 800, from a track assembly, such as 102, the spring 806 is compressed to permit the axle 802 to flex or bow slightly until at least one end of the axle 802 can be removed from one of the side channels, such as an axle mounting hole in first side channel 108. After at least one end of the axle 802 is removed from one of the first side channel, such as 108, the other end of the axle 802 can be removed from the opposing side channel, such as side channel 110. In this manner, the wheel assembly 800 of FIGS. 8A and 8B can be manually removed and replaced relatively quickly and without special tools or equipment. The wheel assembly 1100 of FIG. 11 can be removed and replaced in a similar manner.

As shown in FIG. 1, wheels within a given wheel assembly can occupy unique transverse positions with respect to the wheels of adjacent wheel assemblies, wherein the transverse positions are measured in the direction transverse to the track flow direction. Positioning the wheels in this manner can generally permit more wheels to contact the bottom of a load such as a carton.

Multiple wheels across one or more axles can provide a relatively wide track-type assembly. This type of configuration can provide relatively high load capacity for supporting heavy loads such as multiple cartons of varying sizes and shapes, and can provide relatively reliable and efficient flow through the use of multiple wheels.

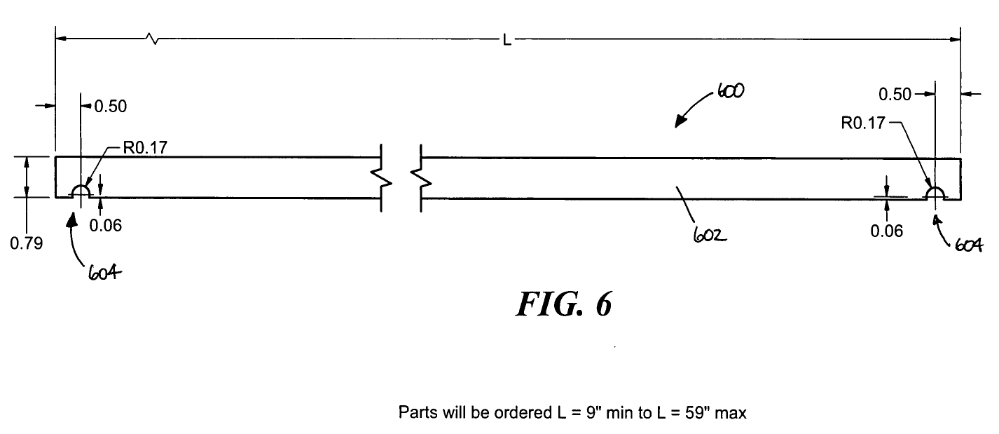

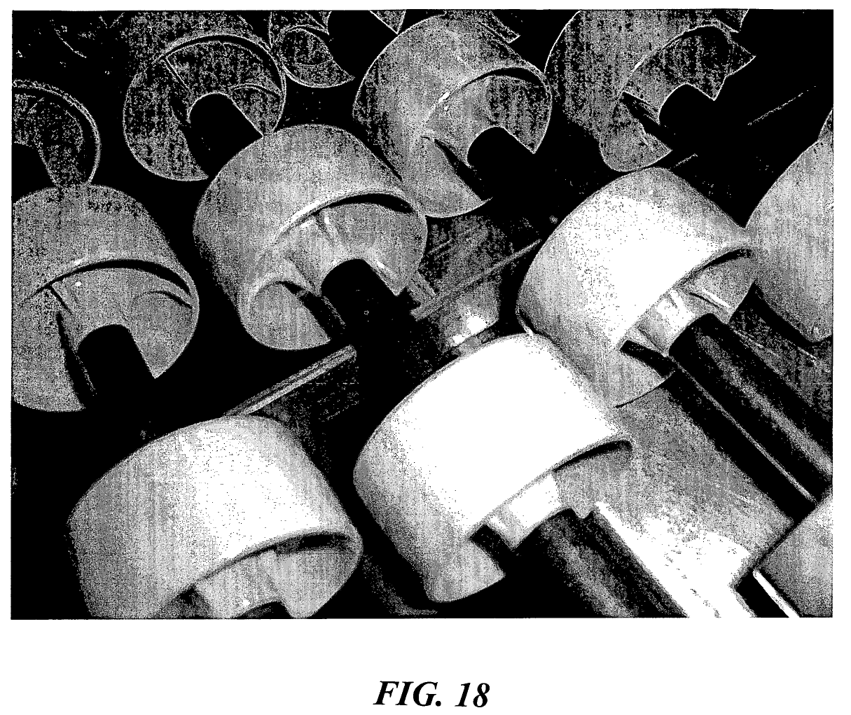

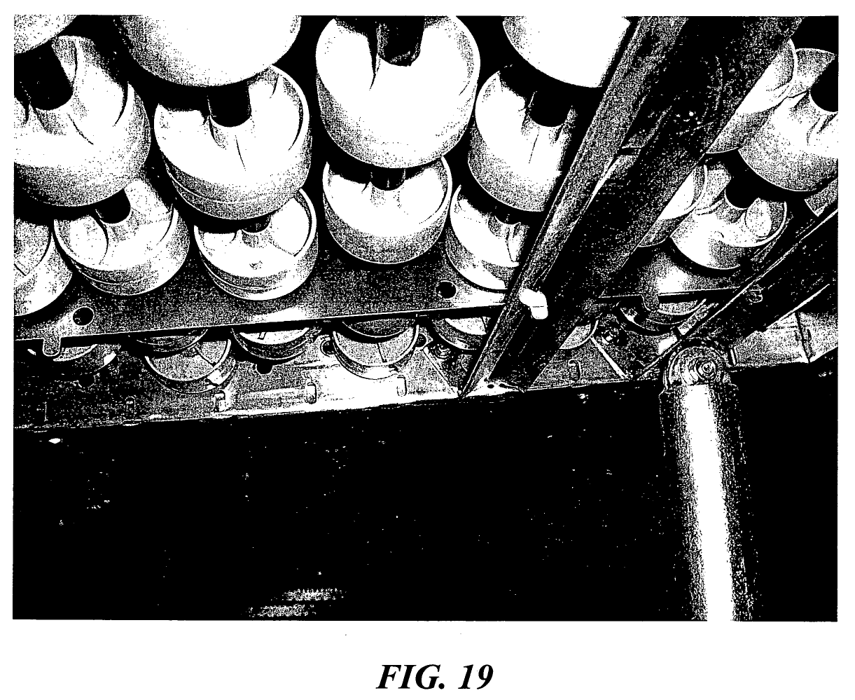

In one embodiment, one or more wheel assemblies can be further supported by a structural support apparatus for a transfer structure in accordance with the invention. FIGS. 6, 16A, 16B, and 17-19 illustrate at least two embodiments of a structural support apparatus in accordance with the invention. The structural support apparatus shown in these figures can increase or otherwise improve the load capacity of one or more wheel assemblies, particularly when the apparatus is installed at an initial loading portion of a transfer structure, such as an entrance end. In one embodiment of a structural support apparatus shown in FIG. 6, a side view of structural support 600 is shown. The structural support 600 shown can include a relatively long body 602, and a series of mounting notches 604. The body 602 can be shaped to provide structural support for one or more wheel assemblies, such as 104 shown in FIG. 1, in a track flow direction. In this example, a support portion 606 can extend the length of the body 602, and one or more wheel assemblies 104 can be in contact along the length of the body 602. The mounting notches 604 can be shaped to mount to a portion of threaded fastening rods, such as 906 in FIG. 9. In use, when the mounting notches 604 are fit over a portion of at least two threaded fastening rods 906, the support portion 606 can contact one or more wheel assemblies 104 and support each of the wheel assemblies in a substantially horizontal orientation.

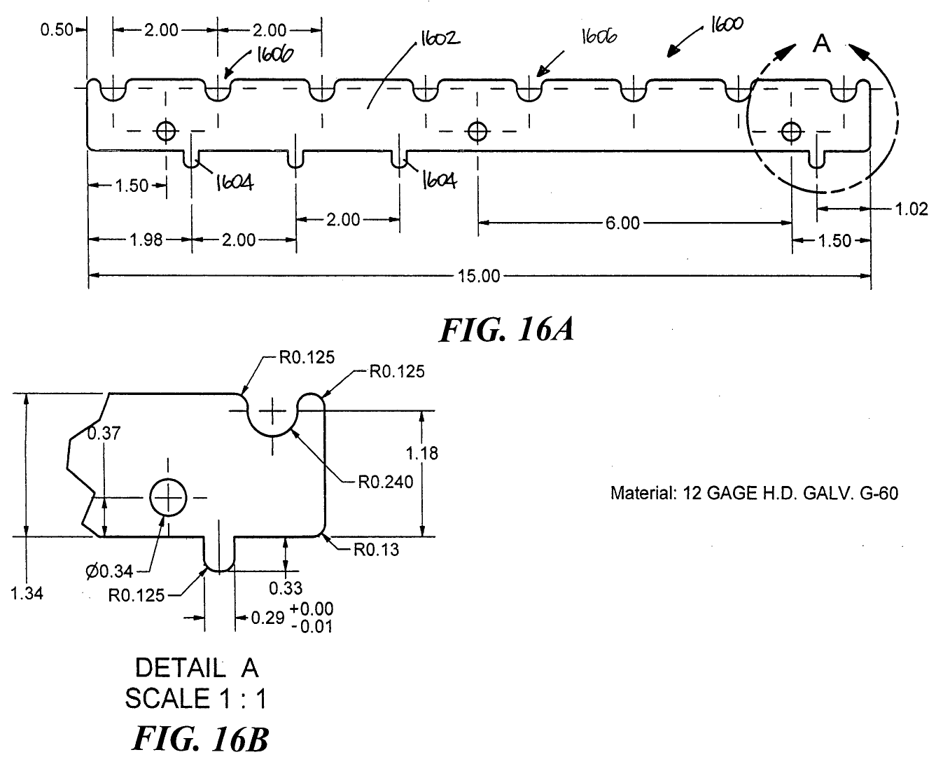

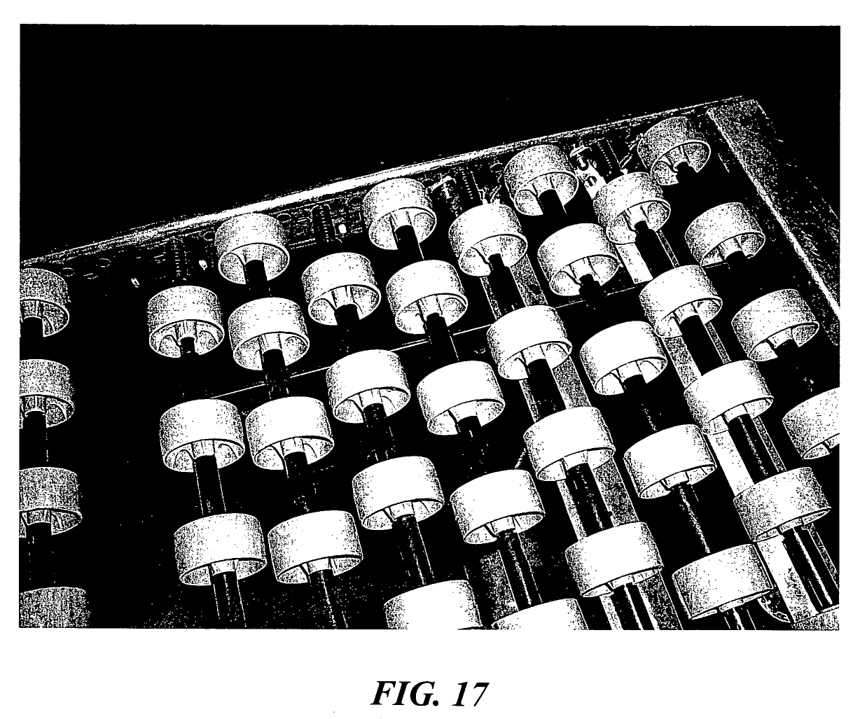

In another embodiment of a support apparatus shown in FIGS. 16A and 16B, a side and detail view of a structural support 1600 is shown. The structural support 1600 shown can include a relatively long body 1602, a series of mounting tabs 1604, and a series of support notches 1606. The body 1602 can be shaped to provide structural support for one or more wheel assemblies, such as 104 shown in FIG. 1, in a track flow direction. In this example, the support notches 1606 can be spaced along the length of the body 1602, and corresponding wheel assemblies 104 can be in contact with the support notches 1606 along the length of the body 1602. Further, the mounting tabs 1604 can be shaped to mount to a portion of a spacer between side channels, such as 900 in FIG. 9. In use, when the mounting tabs 604 are mounted to a spacer 900, such as inserting the tabs 604 into corresponding holes in the spacer 900, the support notches 1606 can contact one or more wheel assemblies 104 and support each of the wheel assemblies in a substantially horizontal orientation. Examples of this particular embodiment of a structural support are shown in FIGS. 17-19 supporting multiple wheel assemblies.

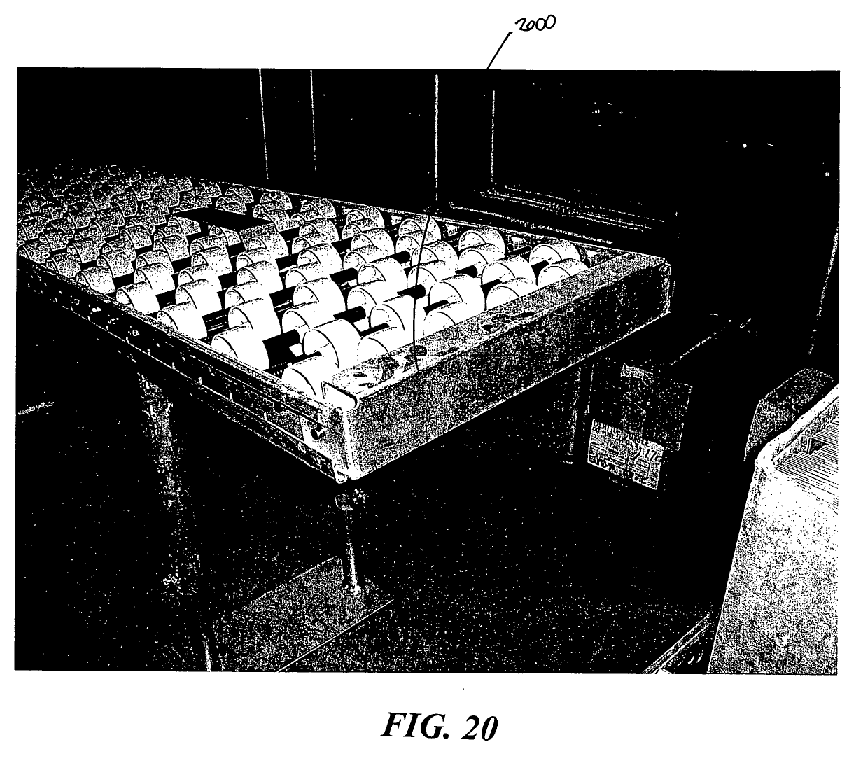

FIGS. 20-24 illustrate other embodiments of features associated with a transfer structure in accordance with the invention. Various connecting devices such as entrance or input end components, edge roller assemblies, diagonally positioned track assemblies, exit or output end components, and other suitable devices, components, and assemblies can be implemented with a transfer structure in accordance with other embodiments of the invention. An example of an entrance or input end component 2000 is shown in FIG. 20. This particular component 2000 can be implemented for instances where loads such as cartons are to placed at an entrance or input end of a transfer structure, and transported from the entrance end to an exit or output end. The input end component 2000 shown can be a channel shaped piece that can be positioned adjacent to and between parallel spaced side channels, such as 2002 and 2004. Corresponding sides of the input end component 2000 can mount within or adjacent to the side channels 2002, 2004. Other configurations and shapes for an input end component can exist in accordance with other embodiments of the invention.

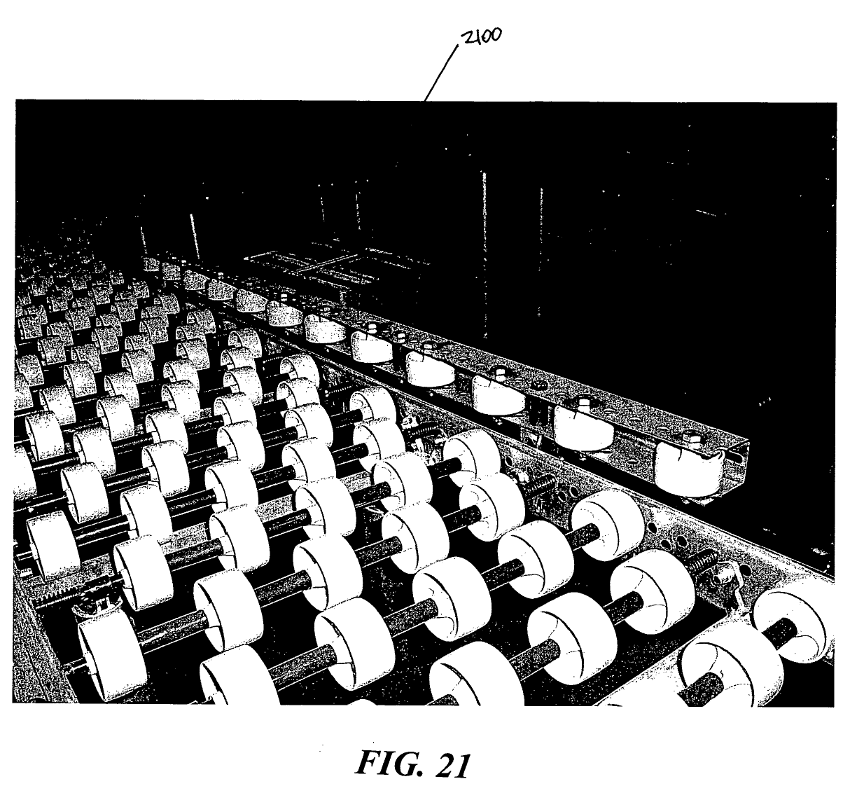

An example of an edge roller assembly 2100 is shown in FIG. 21. This particular assembly 2100 can be implemented for instances where loads such as cartons are to be transferred along an upper surface of a transfer structure and directed or redirected along the length of the transfer structure. In some instances, the transfer structure can be relatively straight, and in other instances, the transfer structure may be curved. In the example shown, the edge roller assembly 2100 can include a series of rollers 2102 mounted on a respective axle 2104, wherein each roller 2102 and axle 2104 assembly is mounted between parallel sides of an edge roller channel 2106. In this embodiment, each of the axles 2104 is positioned in a substantially vertical position to permit the corresponding rollers 2102 to rotate in a direction parallel with the roller direction 2110 of the transfer structure 2108. The edge roller channel 2106 can be mounted adjacent to a side of an associated transfer structure 2108 and further adjacent to the upper surface of the transfer structure 2108. Each of the rollers 2102 is mounted in a position substantially parallel to the roller direction 2110 of the transfer structure 2108. In other embodiments, the edge roller channel can be a curved piece for mounting adjacent to a curved transfer structure, and a series of roller and axle assemblies can be spaced apart along the length of the curved edge roller channel.

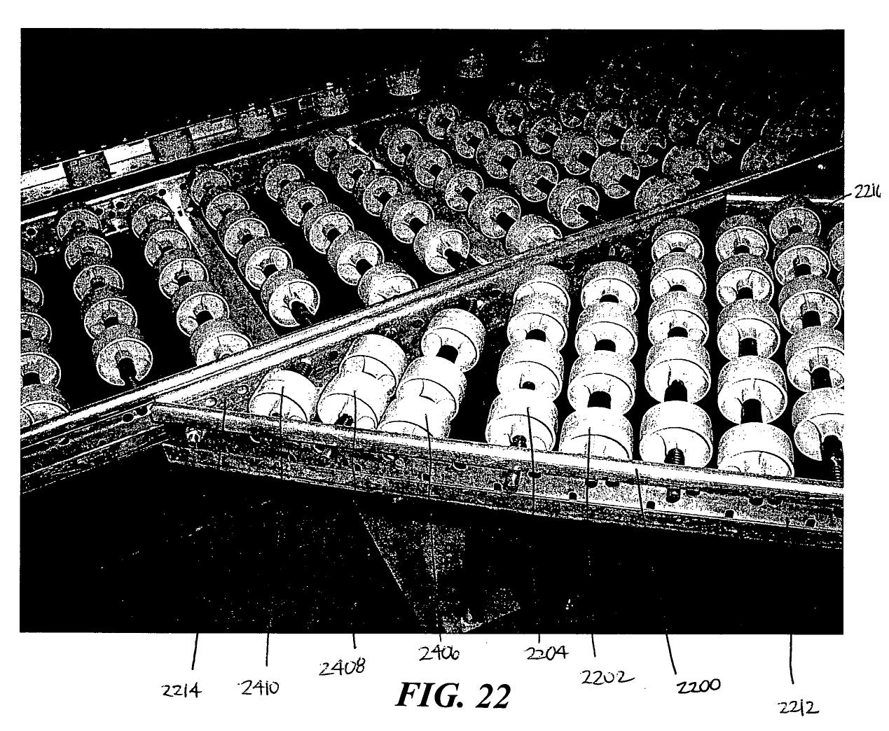

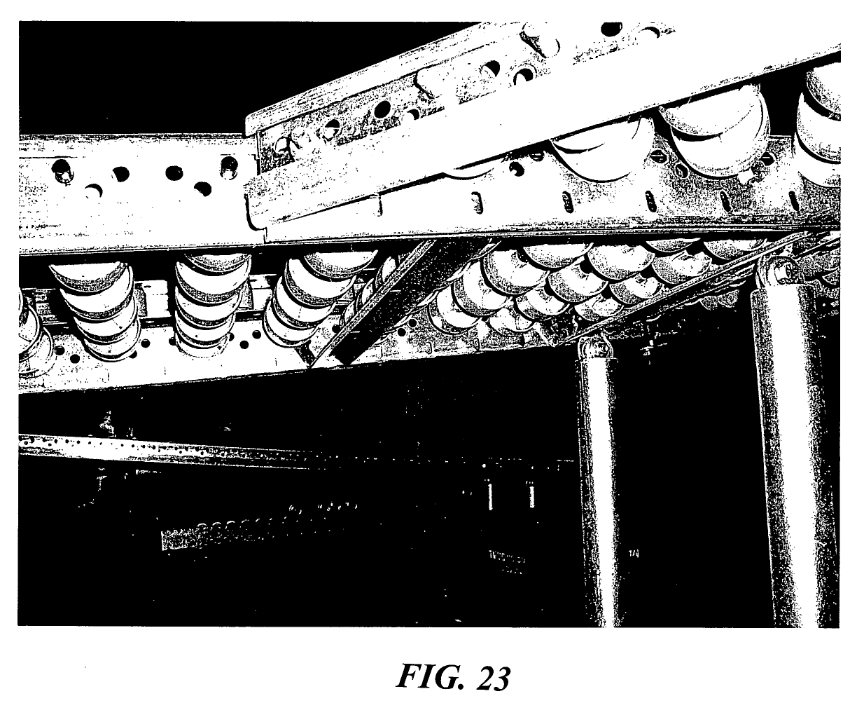

An example of a diagonally positioned track assembly 2200 is shown in FIGS. 22 and 23. This particular assembly 2200 can be implemented for instances where loads such as cartons are to be transferred from one transfer structure oriented at an angle to a receiving transfer structure. A diagonally positioned track assembly 2200 can include a series of progressively shorter wheel assemblies 2202, 2204, 2206, 2208, 2210 adjacent to an end of the track assembly 2200. Each of the relatively shorter wheel assemblies can mount to a side channel 2212 associated with the track assembly 2200, similar to the axle mounting hole configuration described above in FIG. 8. A diagonal channel 2214 can be positioned between parallel spaced side channels 2212, 2216. Each of the relatively shorter wheel assemblies can mount to the diagonal channel 2214, similar to the axle mounting hole configuration described above in FIG. 8.

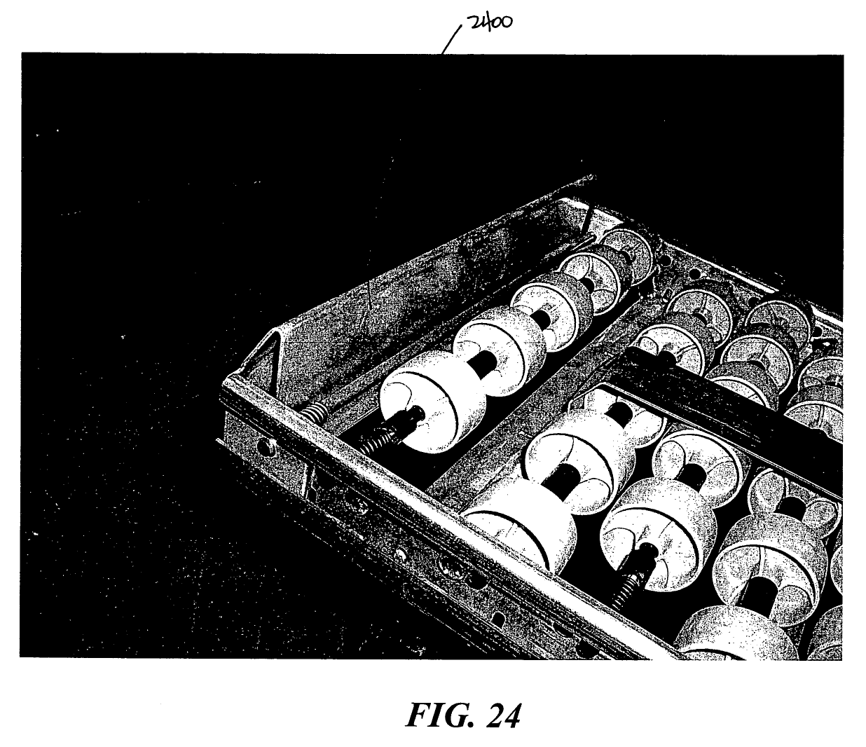

An example of an exit or output end component 2400 is shown in FIG. 24. This particular component 2400 can be implemented, for example, when loads such as cartons are placed at an entrance or input end of a transfer structure, and transported from the entrance or input end to an exit or output end. The exit or output end component 2400 stops or otherwise prevents loads such as cartons from moving past the exit or output end of the transfer structure. The output end component can be a raised angle channel shaped piece that can be positioned adjacent to and between parallel spaced side channels, such as 2402 and 2404. Corresponding sides of the output end component 2400 can mount within or adjacent to the side channels 2402, 2404. Other configurations and shapes for an output end component can exist in accordance with other embodiments of the invention.

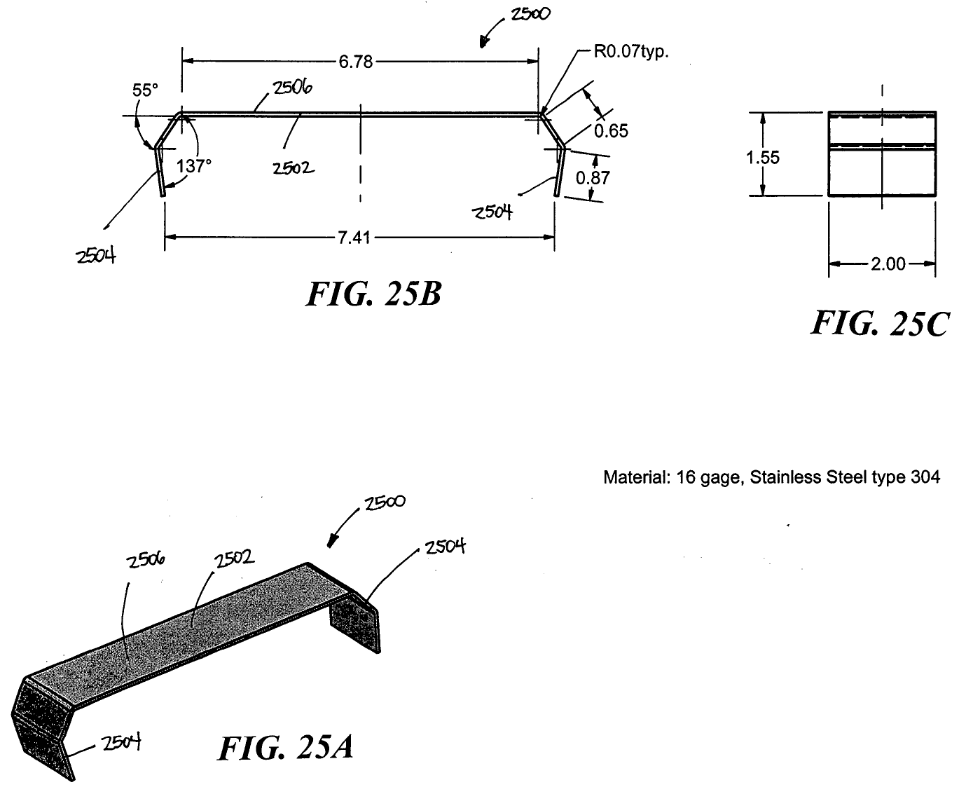

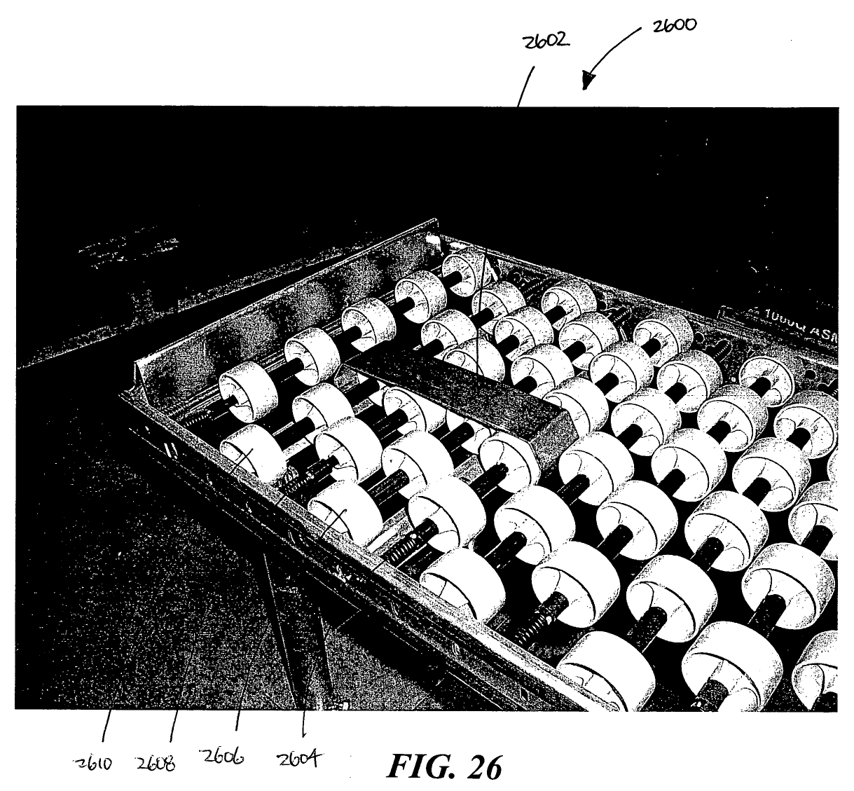

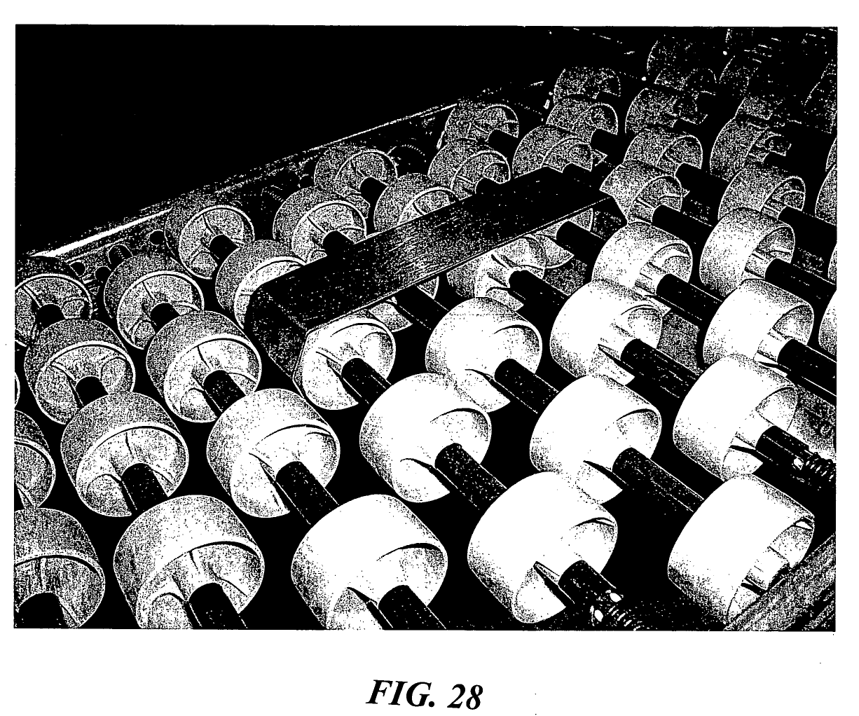

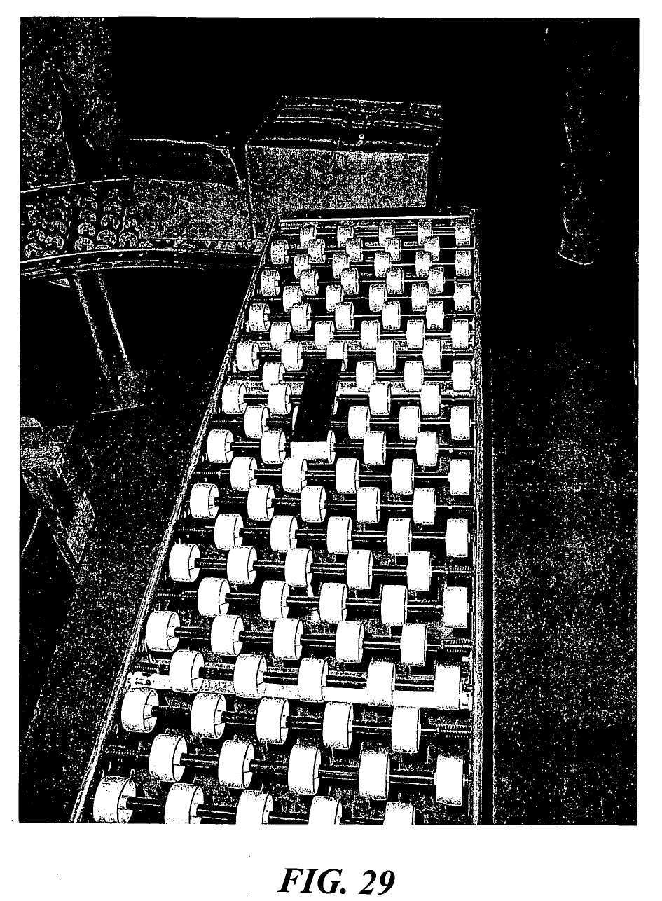

FIGS. 25A, 25B, 25C, and 26-29 illustrate embodiments of a flow control apparatus in accordance with the invention. In one embodiment, a flow control apparatus can be implemented with one or more wheel assemblies associated with a transfer structure. A flow control apparatus can reduce the speed of or otherwise control the movement of a load being transported on a transfer structure. In FIGS. 25A-25C, a flow control apparatus 2500 can include a C-shaped body 2502 with a pair of angled leg sections 2504. The C-shaped body 2502 can be shaped to mount to one or more sets of wheels of one or more adjacent wheel assemblies. For example, as shown in FIG. 26, a flow control apparatus 2600 similar to that shown in FIG. 25, can mount to four adjacent wheels of four adjacent and separate wheel assemblies 2604, 2606, 2608, 2610. Greater or fewer wheels can be accommodated by different embodiments of a flow control apparatus in accordance with the invention.

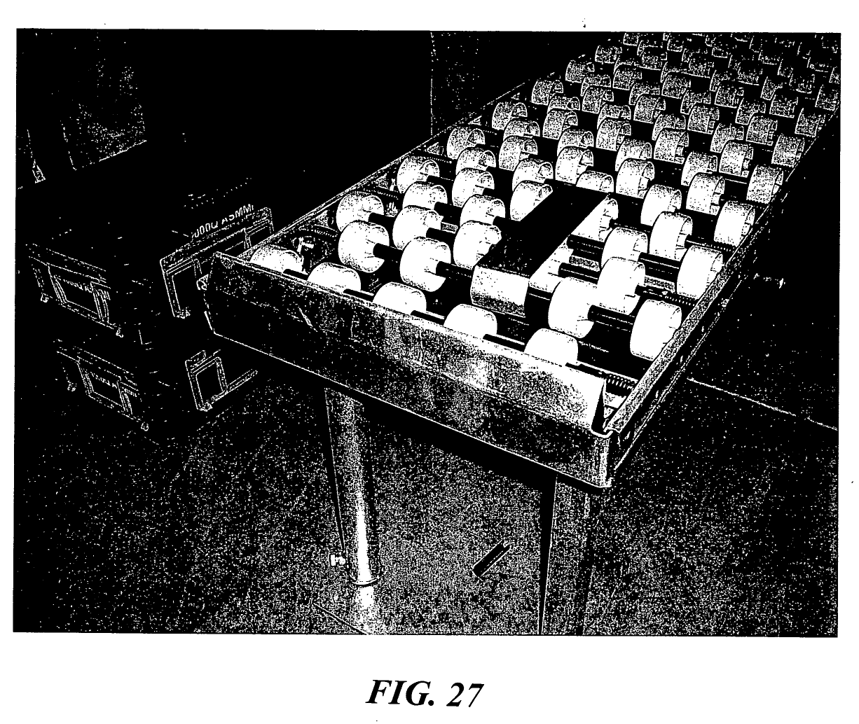

Referring back to FIG. 25A, the pair of angled leg sections 2504 is sized to generally conform with the shape of the wheels of the respective wheel assemblies. The shape of the flow control apparatus permits the body 2502 and angled leg sections 2504 to fit around a portion of one or more wheels of one or more wheel assemblies. The body 2502 can include a relatively smooth or friction section 2506 that faces away from the wheels and can come into frictional contact with a load such as a carton moving along the upper surface of the wheel assemblies of a transfer structure. As shown in FIG. 26, the friction section 2602 can be any width depending on the desired amount of load contact. In use, when the flow control apparatus is mounted to one or more wheels of one or more wheel assemblies, the flow control apparatus prevents or otherwise minimizes the rotation of the wheels, and provides frictional contact against a load such as a carton that comes in contact with the flow control apparatus. As shown in FIGS. 27-29, a flow control apparatus can be positioned at different areas of a transfer structure, including entrance ends, exit ends, and areas between entrance ends and exit ends. Multiple flow control apparatus can be installed on a transfer structure depending on the desired control of loads being transported on the particular transfer structure.

Various methods of installation and for using the various embodiments of the transfer structures shown and described above can be carried out.

While the above description contains many specifics, these specifics should not be construed as limitations on the scope of the invention, but merely as exemplifications of the disclosed embodiments. Those skilled in the art will envision many other possible variations that are within the scope of the invention.

The invention we claim is:

1. A transfer structure for conveying a load from a first location to a second location, comprising:
at least one profile capable of supporting a wheel assembly;
a plurality of wheel assemblies capable of conveying a load, each wheel assembly comprising:
an axle with at least one end capable of mounting to the at least one profile;
at least one wheel rotatably mounted to the axle, the at least one wheel capable of contacting a portion of the load;
a spring capable of maintaining the position of the respective wheel assembly with the at least one profile, and further capable of permitting the manual removal of the respective wheel assembly from the at least one profile when the spring is compressed against either the at least one wheel or the at least one profile.

2. The transfer structure of claim 1, wherein the plurality of wheel assemblies is in a spaced apart relation to permit the load to move from one location on the transfer structure to a second location.

3. The transfer structure of claim 1, wherein each wheel assembly further comprises a means capable of spacing apart the at least one wheel and a second wheel rotatably mounted on the axle.

4. The transfer structure of claim 1, further comprising:
a positioner device capable of maintaining the position of the spring relative to the axle and the at least one wheel.

5. The transfer structure of claim 4, wherein the positioner device comprises a clip capable of encompassing a portion of the spring.

6. The transfer structure of claim 1, further comprising:
an edge roller assembly capable of assisting movement of a load from a first location to a second location, the edge roller assembly comprising:.
at least one edge profile capable of supporting an edge wheel assembly;
a plurality of edge wheel assemblies capable of conveying a load, each edge wheel assembly comprising:
an edge wheel axle with at least one end capable of mounting to the at least one edge profile, wherein the edge wheel axle is positioned substantially perpendicular to the axle;
at least one wheel rotatably mounted to the edge wheel axle, the at least one edge wheel is capable of contacting a portion of the load.

7. The transfer structure of claim 6, wherein the plurality of edge wheel assemblies is in a spaced apart relation to permit the load to move from one location on the transfer structure to a second location.

8. The transfer structure of claim 6, wherein the edge profile is a curved profile. and

9. The transfer structure of claim 1, further comprising:
a member capable of supporting the axle and maintaining the position of the axles when a load is in contact with the at least one wheel.

10. A method of installing a wheel assembly with respect to a pair of spaced apart profiles associated with a transfer structure, comprising:
providing a wheel assembly comprising:
an axle with a first end capable of mounting to a first profile and a second end capable of mounting to a second profile;
at least one wheel rotatably mounted to the axle, the at least one wheel capable of contacting a portion of a load placed on the transfer structure; and
a spring capable of maintaining the position of the wheel assembly with respect to the first profile and the second profile,
mounting the first end of the axle with respect to the first profile;
compressing the spring wherein the second end of the axle can be mounted with respect to the second profile; and
releasing the spring wherein a return force generated by the spring can maintain the position of the wheel assembly with respect to the first profile and the second profile.

11. The method of claim 10, further comprising:
installing a plurality of wheel assemblies with respect to the first profile and second profile.

12. The method of claim 10, further comprising:
compressing the spring wherein the second end of the axle can be removed from mounting with the second profile; and
removing the first end of the axle from mounting with the first profile.

13. A method of conveying a load from first location to a second location using an adaptable transfer structure, comprising:
providing a transfer structure comprising:
a first profile;
a second profile in a spaced apart and parallel relationship with the first profile;
a wheel assembly, comprising:
an axle with a first end capable of mounting to the first profile and a second end capable of mounting to the second profile;
at least one wheel rotatably mounted to the axle, the at least one wheel capable of contacting a portion of a load placed on the transfer structure; and
a spring capable of maintaining the position of the axle and the at least one wheel with respect to the first profile and the second profile, and further capable of permitting the manual removal of the wheel assembly from either the first profile or second profile when the spring is compressed against either the at least one wheel or the at least one profile;
placing a load on an input end of the transfer structure, wherein the at least one wheel is in contact with the load;
conveying the load across a portion of the transfer structure towards an output end.

14. The method of claim 13, wherein the transfer structure comprises a plurality of wheel assemblies with at least one wheel capable of contacting the load and further capable of conveying the load across a portion of the transfer structure towards an output end.

15. The method of claim 13, wherein the transfer structure mounts to at least one track assembly support capable of mounting to a beam associated with a support structure, wherein the first profile and second profile can both mount with respect to the track assembly support.

16. The method of claim 15, wherein the support structure comprises a pallet frame.

17. A wheel assembly for a transfer structure for conveying a load from one location to a second location, the transfer structure comprising at least a first profile and a second profile in a spaced apart relationship, the wheel assembly comprising:
an axle with a first end capable of mounting to the first profile and a second end capable of mounting to the second profile;
at least one wheel rotatably mounted to the axle, the at least one wheel capable of contacting a portion of a load placed on the transfer structure; and
a spring capable of maintaining the position of the axle and the at least one wheel with respect to the first profile and the second profile, and further capable of permitting the manual removal of the wheel assembly from either the first profile or second profile when the spring is compressed against either the at least one wheel or the at least one profile;
wherein a load placed on an input end of the transfer structure can be conveyed from the input end towards an output end of the transfer structure.

18. The wheel assembly of claim 17, wherein the at least one wheel comprises at least one of the following: a polycarbonate resin, a composite material, a plastic, a metal.

19. The wheel assembly of claim 17, further comprising a plurality of wheels capable of contacting the load and further capable of conveying the load across a portion of the transfer structure towards an output end.
